(19) United States
(12) Patent Application Publication
(10) Pub. No.: US 2011/0262715 A1
(43) Pub. Date: Oct. 27, 2011

(54) METHOD OF MANUFACTURING A PRODUCT THAT CONTAINS A SCENTED COMPOUND

(75) Inventors: Petri Nyfords, Helsinki (FI); Janne Jarvenpaa, Veikkola (FI); Hannu Kerovuo, Helsinki (FI); Juha Pippuri, Helsinki (FI)

(73) Assignee: KA AROMA MARKETING OY, Helsinki (FI)

(21) Appl. No.: 13/130,529

(22) PCT Filed: Nov. 20, 2009
(86) PCT No.: PCT/FI2009/050941

§ 371 Date: Jul. 15, 2011

(30) Foreign Application Priority Data
Nov. 20, 2008 (FI) U20080375

(51) Int. Cl. B05D 1/36; B32B 3/14; B05D 1/32

(52) U.S. Cl. 428/195.1; 427/282; 427/265

(57) ABSTRACT

A method of manufacturing a product that contains a scented compound, a product manufactured by this method and the use of such a product, the method includes at least printing one or more scented compounds, which are added to printing ink (3), varnish (4) and/or adhesive (5), on at least one surface of the base material (2) of the product (1) by the screen printing process during printing by a printing screen.

### BACKGROUND OF THE TECHNOLOGY

The invention relates to a method of manufacturing a product that contains a scented compound, to a product manufactured by this method and the use of such a product.

Conventionally, scented compounds have been added to products by dosing them directly to the base material either by immersion or spraying scented compounds, e.g., on printed products. Known techniques have the problem that it is both laborious and expensive to dose the scented compound or the methods do not allow dosing the scented compound in large enough quantities to the printed product. The aroma can also be provided by encapsulating a scent and breaking this later on by rubbing or abrading. Also this method is laborious and technically complicated.

### GENERAL DESCRIPTION OF THE INVENTION

A method is now invented, wherein it is technically particularly advantageous to add a scented compound to the product.

To achieve this object, the invention is characterised in facts, which are presented in the independent claims. The other claims present some preferred embodiments of the invention.

In the product according to the invention, one or more scented compounds are attached to at least one surface of the product by a screen printing process, being admixed with ink, varnish and/or adhesive. All of these are particularly advantageous ways of attaching a scented compound to the printed product. The product containing a scented compound can be manufactured in various ways and a scented compound can be positioned in various spots in the product.

The capacity of the screen printing process to transfer ink, varnish and adhesive is multiple, up to 10-fold, with respect to, e.g., the offset printing technique. In that case, the transfer capacity of the scented compound that is to be transferred is also relatively multiple. Thus, the use of the screen printing process provides an essential advantage over the other printing techniques when transferring, the scented compound.

The screen printing process in this application refers to a printing technique, wherein inks are dosed through a screen to the product to be printed. Generally, screen printing is also called silk screen printing, as it initially employed silk screens. In principle, the invention is suitable for all kinds of screen printing processes; both manual and semi-automatic techniques can be used, as well as automated lines, on which either the screens or the product to be printed move. The properties of the screen may vary freely. In fact, the density of the screen can be used to influence, e.g., as to how much ink and scented compound is printed on the product. With a dense screen, the amount of ink is smaller than with a coarse sieve and, correspondingly, the amount of scented compound also varies according to the density of the screen.

Being accurate, easy and simple to measure, the manufacture of such a product is technically particularly advantageous. For example, it is easy to dose a sufficient amount of scented compound. It does not also need to be added separately, whereby it, is advantageous in terms of process technology and economy. The method is well-suited to a great variety of base materials, and, the base material itself does not need to absorb or bind the scented compound.

One special advantage of the product made by the method over the known technology is that it can be used to easily and accurately adjust the amount of scented compound in the product. The way of printing also provides the advantage that its release can be adjusted. For example, a product can be manufactured, wherein scented compound is printed on the inks by the screen printing process, and this is then partly coated with a breathable varnish. In that, case, the scented compound is released from the product over a long time. Correspondingly, scented compound can be printed on the product in combination with the surface varnish, whereby it is released relatively quicker and in larger proportions.

According to the invention, scented compound is attached to at least one surface of the base material. Such a product can be, e.g., a beer mat board. According to an object of the invention, scented compound is attached to two or more surfaces of the product, such as the opposite surfaces of the base material. Such a product can be, e.g., a cardboard picture or brochure. For example, a product can also be manufactured, on one side of which there is a different scented compound than on the other side.

According to an object of the invention, scented compound is added to an, adhesive, which is further printed by the screen printing process either on the product and/or, e.g., the backing board of the product, which are then attached to each other. This is suitable, e.g., for objects where the scent should be released over a long time. The amount of scent can be adjusted by the amount of scented compound and, for example, by selecting materials and thicknesses for the product and the backing material, which are suitable for the respective object.

The product according to the invention can be a printed publication or a product, on which an ink and/or varnish is printed. The scented compound can be any substance, compound or mixture, which emits at least some kind of a scent that can be sensed or measured. It may contain only one such substance, mixture or compound or it may contain two or more substances, compounds and/or mixtures in different proportions. The scented compound can also be, e.g., a plant or a part thereof that contains, one or more substances, compounds or mixtures that, produce a scent. The scented compound can also be herb extract, for example. The particular scented compound herein refers to a compound that mainly or at least partly produces the particular scent in question. However, the scent of such a particular scented compound may vary; e.g., the scent of an apple may be that of a sour or sweet apple and, e.g., the scent of bread may vary widely.

According to an object of the invention, embossed symbols, depressions and holes, such as embossed symbols by the Braille method or another similar method, are also printed on the product that is printed by the screen printing process. In that case, combinations are preferably provided for the use of, e.g., the blind and sight-impaired. It can also preferably be utilized in objects, where, the product is handled in dim light, for example.

The scented compound according to the invention can also be printed on packaging material, for example. In that case, e.g., a packaging material can preferably be manufactured, which is intended to be used with a product that has an essentially same scent. A packaging material can also be manufactured, which is intended to be used with a product, the scent of which is to be enhanced or limited in some way. This provides extremely versatile possibilities.

According to an object of the invention, the scented compound is allergy-tested and/or does not cause allergies, does not make one hypersensitive, light-sensitive or does not generally irritate those exposed to its influence. The use of such products is especially safe in various objects. The scented compound can preferably also be suitable for alimentary use.

According to an object of the invention, the scented compound contains one or more organic scented compounds. They render the applications according to the invention even more versatile. They provide, for example, scent combinations, which otherwise would have to be made on the level of scented raw materials. For example, by combining the scent of raw tobacco with the scent of vanilla, a combination resembling a vanilla cigar is obtained.

According to an object of the invention, the scented compound contains one or more inorganic scented compounds. They render the applications according to the invention even more versatile.

According to an object of the invention, at least one scented compound is selected from a group containing paper inks, plastic inks, textile inks, UV inks. The paper inks can be solvent-based and water-based. Furthermore, different degrees of gloss, e.g., matt surfaced or glossy inks can be used. In addition, a scratch-off ink, which is used, e.g., in lottery tickets, or a fluorescent ink, which thus binds light and glows in the dark, or light-reflecting inks can also be used. Such an application can be utilized in objects, which should simultaneously have both colour attraction and a scent attraction, such as in the manufacture of lure coatings or, e.g., in scented reflectors or scented hunting waistcoats, the purpose of which is to cover the specific human scent, which the animals avoid.

All plastic inks are generally solvent-based. The plastic inks can also comprise matt surfaced or glossy alternatives. Two-component plastic inks can also be used for metallic surfaces, for example. Furthermore, the plastic inks can comprise pigment inks or base paste inks, which are used in breaking the colours or as prime colours.

Generally, the textile inks are divided into plastisol, one or two-component and watercolour-based inks. Various coating inks, fluorescent inks, and thinners can also be used.

The invention can also exploit inks that dry by ultraviolet light. They correspond to the other inks but require ultraviolet light to dry.

Mixing of the inks can be carried out in the printing plant or the plant can order an ink with a specific tone directly from an ink supplier.

According to an object of the invention, one or more scented compounds are attached, being selected from a group containing:
a scented compound of a tar product, such as tarring or pit tar
a scented compound of a smoke, such as a scented compound of a chimneyless sauna or tar smoke
a scented compound of a drink, such as coffee, cocoa, tea, mead, wine or beer
a scented compound of a plant, such as mint or birch
a scented compound of a spice, such as garlic, black pepper or white pepper
a scented compound of a piece of fruit, such as apple
a scented compound of a flower, such as rose or lily of the valley
a scented compound of a foodstuff, such as bread, plain coffeebread, smoke-cured meat or smoked fish
a scented compound of an animal, such as horse
a scented compound of a berry, such as raspberry

The invention provides extremely wide application alternatives in most diversified objects. They render the applications according to the invention even more versatile.

According to an object of the invention, the base material of the product is selected from a group containing paper, board, cardboard, wood products, plastic, rubber, metal, glass, ceramic products, textiles. They render the applications according to the invention even more versatile.

According to another object of the invention, at least one printing ink, adhesive and/or varnish is also printed on the base material of the product by some other printing method, such as the offset printing technique. Consequently, the method can be utilized in a great variety of applications. It can be used in the initial treatment of the product or already in the after-treatment of the product, or it can be used in a mixed printing technique.

The invention provides advantages in various printed products that contain scented compound. The invention can preferably be utilized, e.g., as, following products: beer mat boards, cardboard pictures, selling racks, bins, display boxes, brochures and catalogues, document cases, folders, mobiles, table racks, floor racks, price wobblers, product packages, packaging materials, casings, packs, brochures, calendars, rulers, displays, containers, dispensers, beer mats, business cards, catalogues, forms, envelopes, holdalls, bags, writing pads, plastic folders, briefcases, background advertisements, product information cards, table talkers, boxes or other equipment or products intended for sales promotion, marketing or direct mailing.

The product can be a semi-finished product or a product and it can be directed, e.g., to sales and marketing, as well as consumers.

### SPECIAL DESCRIPTION OF THE INVENTION

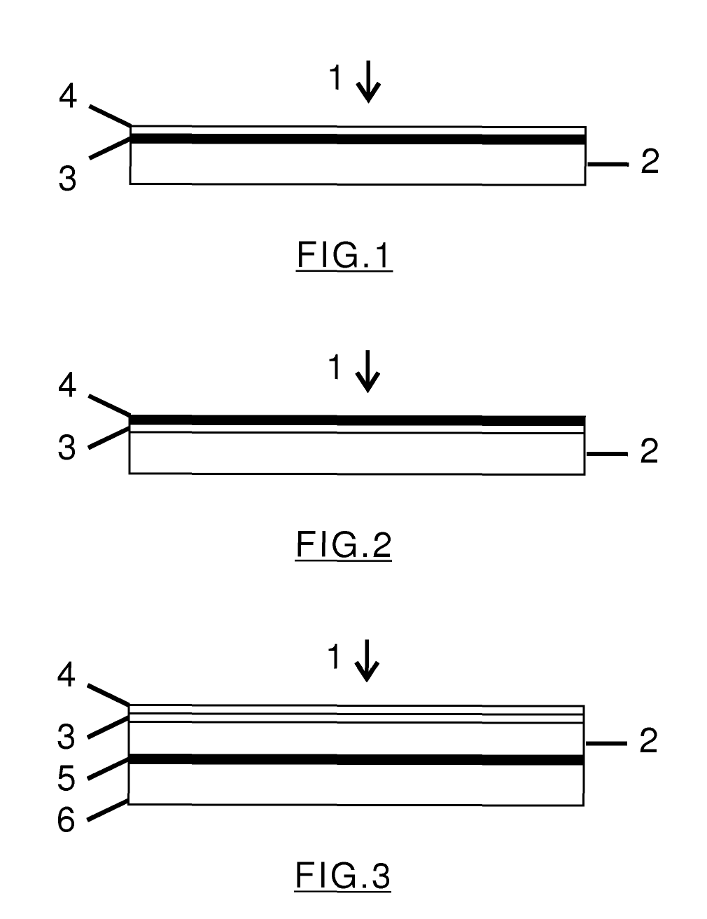

Some applications of the invention are shown in FIGS. 1-3 and in three test examples.

In FIG. 1, the scented compound is printed on ink.

In FIG. 2, the scented compound is printed on varnish.

In FIG. 3, the scented compound is printed on adhesive.

FIG. 1 shows in detail an application of the invention, illustrating the side sectional elevation of a beer mat board. The product, in this case, the beer mat board 1 comprises, as base material 2, a board on which printing inks 3 and varnish 4 are printed by the screen printing process. The scented compound is added to the printing ink 3.

FIG. 2 shows in detail an application of the invention, illustrating the side sectional elevation of a shelf talker 1. The product 1 comprises, as base material 2, a board on which printing inks 3 and screen printing varnish 4 are printed by the screen printing process. In this example, the scented compound is added to the screen printing varnish 4.

FIG. 3 shows in detail an application of the invention, illustrating the side sectional elevation of a primed selling rack. The selling rack 1 comprises, as base material 2, a board on which printing inks 3 and varnish 4 are printed by the screen printing process, and on the opposite side thereof, an adhesive 5 is printed to which the scented compound is added. A backing board 6 is further attached to the adhesive 5 that is attached to the base material 2.

In the following, examples are described in which the scented products are used
1. Woodland smoke—a beer mat
2. Softener—a shelf talker for softeners
3. Scented raw materials: green apple, peppermint, coffee and leather—plastic and cardboard bases

In Test1, 20% of scented raw material (woodland smoke, i.e., the tar sauna scent of Emendo's) was mixed with the water-based varnish intended for the screen printing machine. 50% of the printing surface was covered in order for the beer mat to function after varnishing, i.e., to absorb any drink spilled on it. In the test, it was observed that as late as 2 months after the manufacture, humidity still strongly activated the scent of the beer mat.

In Test 2, a shelf talker for laundry softeners was manufactured. The scent was mixed with a water-based screen printing varnish. Because of the strong smell of the raw material, the mixing percentage was 10% of scented raw material. As a result, a really strong scent was obtained, which was extremely easy to recognise and which remained strong and recognisable (regardless of the small physical size of the product) over a considerably long time (considerably longer than Korpisavu).

Test 3 included a base material, wherein 10% of scented raw material was mixed with the water-based screen printing varnish and it was applied on 4 different materials. After printing, the products were dried in a heat tunnel. The base material comprised plastic and three different grades of cardboard. The results obtained are shown in Table 1.

A few facts can clearly be observed in this test printing. The recognisability varies according to the scent—some scents are stronger by nature. For example, peppermint lasted longer than the scent of leather. Regardless of the base material used, all scents were easy to recognise but the scents that were printed, e.g., on plastic evaporated quicker than those implemented on an absorbing material, such as cardboard. In addition to the material on which the scent is spread, the duration of the scent is also influenced by the scent itself. It is obvious that the duration of the scent is directly influenced by the ability of the material to absorb the combination of varnish and scent. Some scents could not be clearly recognised.

To improve the recognisability, a picture illustrating the origin of the scent was added to the product in addition to the scent. It was obvious that this made the recognition of the scent easier.

It is also noticeable that the scents keep for a considerably longer time, if the product is not in contact with air. Thus, it is possible to store the scented products for quite a long time before use. In specific applications, it is thus preferable to coat or pack the product hermetically to prolong the shelf life of the scented compound.

TABLE 1
Recognisability and shelf life of scents on different base materials

| | Scents: | | | |
|---|---|---|---|---|
| Base material | Green Apple | Peppermint | Black Coffee | Leather |
| Coated cardboard | Easy to recognise | Easy to recognise | Easy to recognise | Easy to recognise |
| 300 g Galeria Art Silk | Keeps relatively long, | Evaporates quicker, | Evaporates quicker, | Evaporates quicker, |
| | about 3 weeks | about 7 days | about 7 days | about 7 days |
| Uncoated cardboard | Easy to recognise | Easy to recognise | Easy to recognise | Easy to recognise |
| 300 g Edixion | Keeps relatively long, | Evaporates quicker, | Evaporates quicker, | Evaporates quicker, |
| | about 2 weeks | about 5 days | about 5 days | about 5 days |
| Polypropylene frosted | Sufficiently recognisable | Sufficiently recognisable | Sufficiently recognisable | Sufficiently recognisable |
| 0.5 mm | Very short shelf life, | Very short shelf life, | Very short shelf life, | Very short shelf life, |
| | 2-3 days | 2-3 days | 2-3 days | 2-3 days |

1-12. (canceled)

13. A method for manufacturing a product containing a scented compound, which comprises at least the following stage:
one or more scented compounds, which are added to printing ink (3), varnish (4) and/or adhesive (5), are added during printing by a printing screen by the screen printing process on at least one surface of the base material (2) of the product (1).

14. The method according to claim 13, wherein at least one scented compound is added to the printing ink (3).

15. The method according to claim 13, wherein at least one scented compound is added to the printing varnish (4).

16. The method according to claim 13, wherein at least one scented compound is added to the printing adhesive (5).

17. The method according to claim 13, wherein the scented compound is printed on two or more surfaces of the product (1).

18. The method according to claim 13, wherein the scented compound contains one or more scented organic compounds.

19. The method according to claim 13, wherein the scented compound contains one or more scented inorganic compounds.

20. The method according to claim 13, wherein at least one scented compound is selected from the group consisting of paper inks, plastic inks, textile inks, UV inks, and phosphorous inks.

21. The method according to claim 13, wherein at least one scented compound is selected from the group consisting of:
a scented compound of a tar product, such as tarring or pit tar;
a scented compound of a smoke, such as a scented compound of a chimneyless sauna or tar smoke;
a scented compound of a drink, such as coffee, cocoa, tea, mead, wine or beer;
a scented compound of a plant, such as mint or birch;
a scented compound of a spice, such as garlic, black pepper or white pepper;
a scented compound of a piece of fruit, such as apple;
a scented compound of a flower, such as rose or lily of the valley;
a scented compound of a foodstuff, such as bread, plain coffee bread, smoke-cured meat or smoked fish;
a scented compound of an animal, such as horse; and
a scented compound of a berry, such as raspberry.

22. The method according to claim 13, wherein the base material (2) of the product (1) is selected from the group consisting of: paper, board, cardboard, wood products, plastic, rubber, metal, glass, ceramic products, and textiles.

23. The method according to claim 13, wherein at least one printing ink, varnish, embossed symbols, depressions and/or holes are also printed on the product (1) by some other printing method, such as the offset printing technique or letterpress.

24. A product (1) containing a scented compound, manufactured by the method according to claim 13.
